(19) United States
(12) Patent Application Publication
(10) Pub. No.: US 2006/0203117 A1
(43) Pub. Date: Sep. 14, 2006

(54) Video monitoring system using variable focal length lens

(75) Inventors: Cheong Soo Seo, Seoul (KR); Gyoung Il Cho, Seoul (KR); Sang Hyune Baek, Suwon (KR)

Correspondence Address: Vernon R. Yancy, Esq.;Law Offices of Park and Associates, Suite 1722, 3600 Wilshire Blvd., Los Angeles, CA, 90010, US

(73) Assignees: STEREO DISPLAY, INC.; ANGSTROM, INC.

(21) Appl. No.: 11/076,688

(22) Filed: Mar. 10, 2005

(51) Int. Cl. G03B 13/00; H04N 5/232

(52) U.S. Cl. 348/345

(57) ABSTRACT

A video monitoring system includes at least one camera system, an objective lens system, and at least one micromirror array lens configured to focus an objective image received by the objective lens system onto an image sensor. In another embodiment, a method in a video monitoring system is presented. The method includes the steps of receiving an object image, and adjusting a micromirror array lens to focus the object image. The advantages of the present invention include providing clear images and fast tracking and focusing of moving objects, and may also include tracking of moving objects without or with changing the attitude of the camera. If the camera attitude is not changed for tracking of moving objects, the present invention can reduce the size and cost.

### FIELD OF THE INVENTION

The present invention relates to optical systems in general and more specifically to video monitoring systems.

### BACKGROUND OF THE INVENTION

Video monitoring systems are widely used for security purposes, safety, and traffic monitoring. Analog closed-circuit television (CCTV) used with or without a VCR recording system is very popular in this application. However, digital video recording (DVR) systems are quickly replacing conventional analog recording systems. Furthermore, many kinds of general and/or application-oriented image processing methods have been developed to be used in connection with the various monitoring systems. However, despite these improvements, little has been done to improve the monitoring cameras, camera mounting, and/or attitude control mechanisms.

Therefore, what is needed is a video monitoring system providing clear images and fast tracking and focusing of moving objects.

### SUMMARY OF INVENTION

The present invention addresses the problems of the prior art and provides a video monitoring system using a variable focal length lens.

In one embodiment, a video monitoring system (optical system) includes at least one camera system, an objective lens system this is configured to receive an object image, at least one micromirror array lens that is optically coupled to the objective lens system and configured to focus the object image received by the objective lens system onto an image sensor. The image sensor is optically coupled to the micromirror array lens and configured to receive the focused object image from the micromirror array lens and to sense the focused object image. The optical system also includes an image storage system that is communicatively coupled to the at least one camera system and configured to store the object image received by the at least one camera system.

In one embodiment, the optical system also includes an image display device, communicatively coupled to the at least one camera system and configured to display the object image received by the at least one camera system. In one embodiment, the image display device is a monitor.

In another embodiment, the image storage system may be an analog recording system or a digital recording system. In another embodiment, the optical system also includes a zoom device. In one embodiment, the zoom device is a motor driven zoom or a manual zoom.

In another embodiment, the optical system also includes an auto-focus device. In one embodiment, the auto-focus device may be a motor driven auto-focus device or a manual auto-focus device. In one embodiment, auto-focus is performed using the micromirror array lens.

In another embodiment, the optical system also includes an image processor that is communicatively coupled to the image sensor, and configured to process the object image sensed by the image sensor and to generate image data and position information of the object. In one embodiment, the image processor includes an object identification algorithm, an object recognition algorithm, and/or an object tracking algorithm.

In another embodiment, the optical system also includes a tracking controller, communicatively coupled to the image processor, configured to generate a tracking signal to control an attitude of the camera system, an optical axis of the micromirror array lens, and/or a focal length of the micromirror array lens.

In another embodiment, the optical system also includes an attitude control algorithm to control the attitude of the camera system, an image processing algorithm to process the object image sensed by the image sensor, and/or an object identification and tracking algorithm to identify and track objects.

In another embodiment, the optical system also includes a camera attitude driving mechanism that is mechanically coupled to the camera system, and configured to adjust camera system tilt and/or camera system pan. In another embodiment, the camera attitude driving mechanism includes a tilt motor and/or a pan motor.

In another embodiment, the optical system also includes a motion sensor that is communicatively coupled to the camera system, and configured to sense motion of a moving object.

In another embodiment, the optical system also includes an image transmission system that is communicatively coupled to the camera system, and configured to transmit images from the camera system. In one embodiment, the image transmission system includes a wire, a wireless connection, and/or an internet connection. In another embodiment, the wireless connection includes radio waves and/or infrared waves.

In another embodiment, the optical system also includes a motion sensor, communicatively coupled to the camera system, configured to sense motion of a moving object. In another embodiment, the optical system also includes an image transmission system, communicatively coupled to the camera system, configured to transmit images from the camera system. In one embodiment, the image transmission system includes a wire, a wireless connection, and/or an internet connection. In one embodiment, the wireless connection includes radio waves and/or infrared waves.

In yet another embodiment, a method in a video monitoring system is presented. In the method, an object image is received, and a micromirror array lens is adjusted to focus the object image, and wherein the object image focused by the micromirror array lens is then stored. In another embodiment of the method, the micromirror array lens is controlled to automatically focus on the object image. In another embodiment of the method, the micromirror array lens is controlled to zoom onto the object image. In another embodiment of the method, the micromirror array lens is controlled to track a moving object. In another embodiment of the method, three-dimensional information pertaining to the object image is produced.

The advantages of the present invention include providing clear images and fast tracking and focusing of moving objects, and may also include tracking of moving objects without or with changing the attitude of the camera. If the camera attitude is not changed for tracking of moving objects, the present invention can reduce the size and cost.

These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a schematic representation of a general configuration of a video monitoring system;

FIG. 2 is a schematic representation of an imaging system (camera system or video camera) using a micromirror array lens, according to one embodiment of the present invention;

FIGS. 3A-3B are schematic representations illustrating measurement of object distance at two different times, according to one embodiment of the present invention;

FIGS. 4A-4B are schematic representations illustrating tracking of an object by changing the optical axis of the camera, according to one embodiment of the present invention;

FIGS. 5A-5B are schematic representations illustrating changing of the optical axis of a micromirror array lens, according to one embodiment of the present invention;

FIGS. 6A-6C are schematic representations illustrating acquisition of three-dimensional information, according to one embodiment of the present invention; and

FIG. 7 is a flow diagram of a method in a video monitoring system, according to one embodiment of the present invention.

### DETAILED DESCRIPTION OF EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

The following US patents are hereby incorporated by reference: U.S. Pat. Nos. 6,783,286; 6,477,918; 6,392,693; 6,792,359; 6,792,323; 6,789,015; 6,771,306; 6,744,462; 6,711,687; 6,646,675; 6,556,653; 6,693,519; 6,690,294; 6,667,764; 6,636,148; 6,396,403; 6,262,768; 5,935,190; and 5,581,297. Furthermore, the following US patent applications are hereby incorporated by reference: U.S. patent application Ser. No. 10/855,554, filed May 27, 2004; U.S. patent application Ser. No. 10/855,715, filed May 27, 2004; U.S. patent application Ser. No. 10/855,287, filed May 27, 2004; U.S. patent application Ser. No. 10/806,299, filed Mar. 23, 2004; U.S. patent application Ser. No. 10/822,414, filed Apr. 12, 2004; U.S. patent application Ser. No. 10/887,536, filed Jul. 9, 2004; patent application Ser. No. 10/979,619, filed Nov. 2, 2004; and U.S. patent application Ser. No. 10/896,146, filed Jul. 12, 2004.

The present invention relates to a video monitoring system which uses a micromirror array lens (MMAL) to obtain clear images. The video monitoring system may change focus and track objects without macromovements. The video monitoring system may have a simpler structure, be more reliable, and provide more clear images than prior art approaches. Furthermore, by using MMAL, the video monitoring system may provide automatic focusing (auto-focus) without moving the objective lens.

Thus, the video monitoring system using MMAL may provide the following features and advantages: implementation of automatic focusing and zooming without movement of objective lens (refer to U.S. patent application Ser. No. 10/896,146, filed Jul. 12, 2004 and U.S. patent application Ser. No. 10/806,299, filed Mar. 23, 2004, both incorporated herein by reference), production of three-dimensional information regarding an object image (refer to U.S. patent application Ser. No. 10/822,414, filed Apr. 12, 2004, incorporated herein by reference), and tracking of an object without changing camera attitude (refer to U.S. patent application Ser. No. 10/979,619, filed Nov. 2, 2004, incorporated herein by reference).

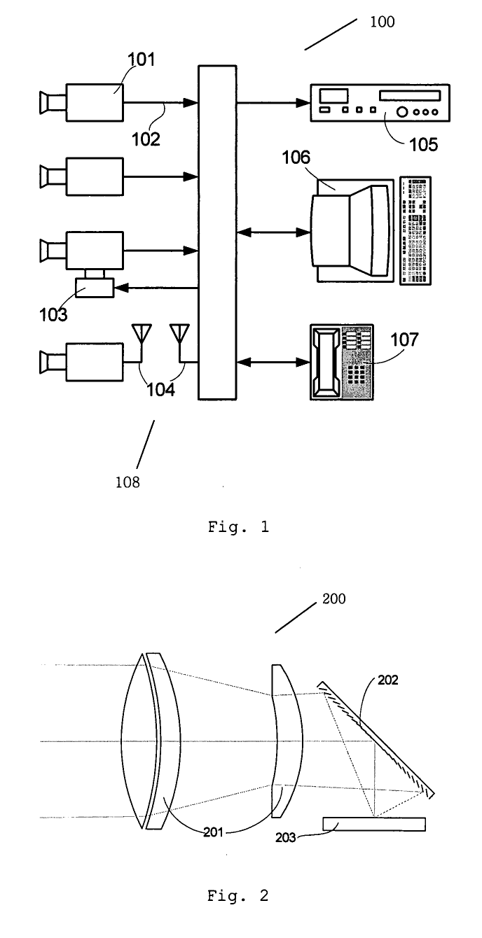

FIG. 1 is a schematic representation of a general configuration of a video monitoring system 100. In the embodiment, the video monitoring system 100 includes video cameras 101 and data transmission media 108. The data transmission media 108 may include a data transmission line 102 or a data transmitting and receiving antenna 104, as shown in FIG. 1. The video monitoring system 100 also includes a camera attitude control mechanism 103, configured to control the tilt and/or pan of the video cameras 101. The video monitoring system 100 also includes an image recording system 105, configured to record images. The image recording system 105 may be, for example, an analog or a digital recording system. The video monitoring system 100 may also include a computer 106, configured to record images and/or control the video cameras 101. The video monitoring system 100 also may include a telephone and/or internet connection 107, configured to transmit and receive data and control commands for the video cameras 101.

In one embodiment a video monitoring system (optical system) includes at least one camera system. The at least one camera system includes an objective lens system, configured to receive an object image, and at least one micromirror array lens, optically coupled to the objective lens system, configured to focus the object image received by the objective lens system onto an image sensor. The image sensor is optically coupled to the micromirror array lens, and configured to receive the focused object image from the micromirror array lens and to sense the focused object image. The optical system also includes an image storage system, communicatively coupled to the at least one camera system, configured to store the object image received by the at least one camera system.

In one embodiment, the optical system also includes an image display device, communicatively coupled to the at least one camera system, configured to display the object image received by the at least one camera system. In one embodiment, the image display device is a monitor.

In another embodiment, the image storage system may be an analog recording system or a digital recording system. In another embodiment, the optical system also includes a zoom device. In one embodiment, the zoom device is a motor driven zoom or a manual zoom. In one embodiment, zoom is performed using the micromirror array lens. In another embodiment, the optical system also includes an auto-focus device. In one embodiment, the auto-focus device may be a motor driven auto-focus device or a manual auto-focus device. In one embodiment, auto-focus is performed using the micromirror array lens

In another embodiment, the optical system also includes an image processor, communicatively coupled to the image sensor, configured to process the object image sensed by the image sensor and to generate image data and position information of the object. In one embodiment, the image processor includes an object identification algorithm, an object recognition algorithm, and/or an object tracking algorithm. In another embodiment, the optical system also includes a tracking controller, communicatively coupled to the image processor, configured to generate a tracking signal to control an attitude of the camera system, an optical axis of the micromirror array lens, and/or a focal length of the micromirror array lens. In another embodiment, the optical system also includes an attitude control algorithm to control the attitude of the camera system, an image processing algorithm to process the object image sensed by the image sensor, and/or an object identification and tracking algorithm to identify and track objects.

In another embodiment, the optical system also includes a camera attitude driving mechanism, mechanically coupled to the camera system, configured to adjust camera system tilt and/or camera system pan. In another embodiment, the camera attitude driving mechanism includes a tilt motor and/or a pan motor.

In another embodiment, the optical system also includes a motion sensor, communicatively coupled to the camera system, configured to sense motion of a moving object. In another embodiment, the optical system also includes an image transmission system, communicatively coupled to the camera system, configured to transmit images from the camera system. In one embodiment, the image transmission system includes a wire, a wireless connection, and/or an internet connection. In one embodiment, the wireless connection includes radio waves and/or infrared waves.

FIG. 2 is a schematic representation of an imaging system (camera system or video camera) 200 using a micromirror array lens. In the embodiment depicted with respect to FIG. 2, the imaging system 200 includes an objective lens system 201, configured to receive an object image. The configuration of the lens system 201 shown in FIG. 2 is exemplary only. The lens system 201 may include any number of lenses and have different lens shapes. Furthermore, the lens system 201 may be combined with a conventional zoom lens system. A micromirror array lens (MMAL) 202 is optically coupled to the lens system 201, configured to focus the image received from the objective lens system 201. An image sensor 203 is optically coupled to the micromirror array lens 202, configured to sense the image focused by the micromirror array lens 402. The image sensor 203 may be a CCD (charge coupled device) or CMOS (complementary metal-oxide semiconductor) or other type of image sensor.

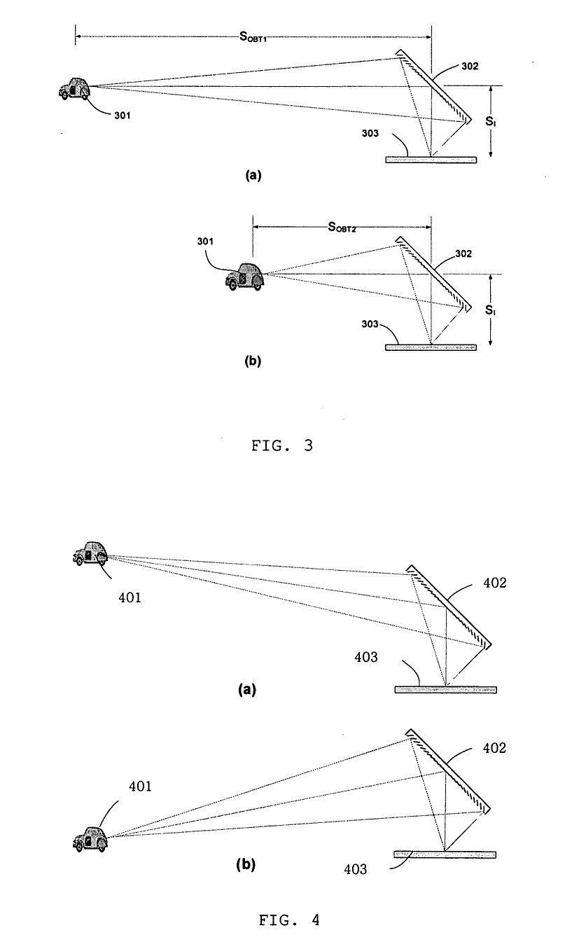

FIGS. 3A-3B are schematic representations illustrating measurement of object distance at two different times. In other words, FIGS. 3A-3B are schematic representations of focusing on a object without macroscopic movement, using the micromirror array lens. In the embodiment, a tracking camera with a micromirror array lens 302 is optically coupled to an image sensor 303. The distance from the center of the tracking camera 302 to the image sensor 303 is S_{I}. The distance from the center of the tracking camera 302 to the tracked object 301 is S_{OBT1} at time=t₁, as shown in FIG. 3A and S_{OBT2} at time=t₂, as shown in FIG. 3B. By fixing the distance (S_{I}) from the center of the tracking camera 302 to the image sensor 303, and controlling the effective focal length (f) of the tracking camera 302 the distance to the tracked object 301 (S_{OBT}) may be determined using the formula:
1/f=1/S_{OBT}+1/S_{I}

FIGS. 4A-4B are schematic representations illustrating tracking of an object by changing the optical axis of a camera. In other words, FIGS. 4A-4B are schematic representations of tracking an object without a camera attitude change, using a micromirror array lens. In the embodiment, the tracked object 401 may be imaged in the center of image sensor 403 by adjusting the optical axis of a micromirror array lens of the tracking camera 402. Thus, it is not necessary to use a servo or gimbal system to control the attitude of tracking camera 402. Adjusting the view angle of the tracking camera 402 by adjusting the optical axis of a micromirror array lens allows the tracking camera to track the object 401 very quickly, because the response time of a micromirror array lens is very fast.

FIGS. 5A-5B are schematic representations illustrating changing of the optical axis of a micromirror array lens. A micromirror array lens 551 includes micromirrors 552. A light ray 553 is focused onto a point 554. In FIG. 5A, optical axis 556 has the same direction as a vector 555 normal to the plane of the micromirror array lens 551. In FIG. 5B, optical axis 556 has a different direction from the vector 555 normal to the plane of the micromirror array lens 551. As shown in FIGS. 5A-5B, by changing the optical axis of the micromirror array lens 551 by controlling each micromirror 552, the micromirror array lens 551 may focus two different rays with different incident angles to the normal vector of a micromirror array on the same point 554.

Referring again to FIGS. 4A-5B, the micromirror array lens is capable of having its optical axis changed very rapidly. By changing the optical axis of the micromirror array lens through adjustment of the micromirrors, the imaging camera/tracking system may image the tracked object in the center of the image sensor without adjustment of the tracking camera/tracking system attitude. Rapid changes to the optical axis of the micromirror array lens allow the imaging camera/tracking system to track fast-moving objects and reduce dropout rate.

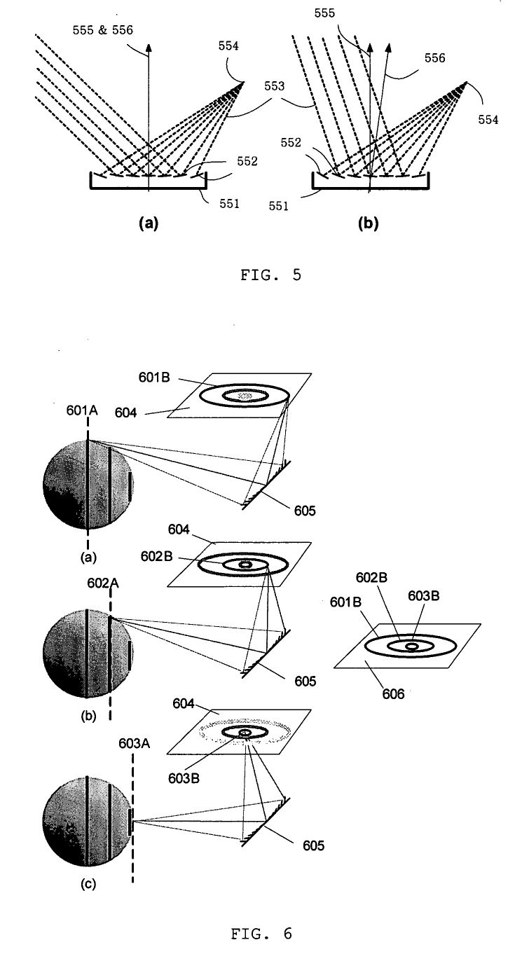

FIGS. 6A-6C are schematic representations illustrating acquisition (generation) of three-dimensional information. FIG. 6A depicts a camera system with a micromirror array lens 605 in a first focused plane 601A. The in-focus image 601B projected onto the image sensor 604 corresponds to the camera system 605 in focused plane 601A. FIG. 6B depicts the camera system 605 in a second focused plane 602A. The in-focus image 602B projected onto the image sensor 604 corresponds to the camera system 605 in focused plane 602A. FIG. 6C depicts the camera system 605 in a third focused plane 603A. The in-focus image 603B projected onto the image sensor 604 corresponds to the camera system 605 in focused plane 603A. A three-dimensional image profile 606 with all-in-focused image and depth information is provided, using the in-focus images 601B, 602B, and 603B.

The focal (focused) plane of an imaging device is changed by changing the focal length of each micromirror array lens. An imaging unit includes one or more two-dimensional image sensors that taking an original two-dimensional image at each focal plane. An image processing unit generates the all-in-focus image and the depth information for in-focus image from original two-dimensional images. All the processes are achieved within a unit time which is less than or equal to the afterimage time of the human eye.

The image sensor takes original two-dimensional images with different focal planes that are shifted by changing the focal length of the micromirror array lens. The image processing unit extracts in-focus pixels or areas from original pictures at different focal planes and generates an all-in-focus image. Three-dimensional information of the image can be obtained from the focal plane of each in-focus pixel.

By changing the focal length of the camera system 605 in multiple steps, a single imaging camera/tracking system using a micromirror array lens may acquire three-dimensional information about a tracked object. The principles of acquiring three-dimensional information are described in detail in U.S. patent application Ser. No. 10/822,414, filed Apr. 12, 2004.

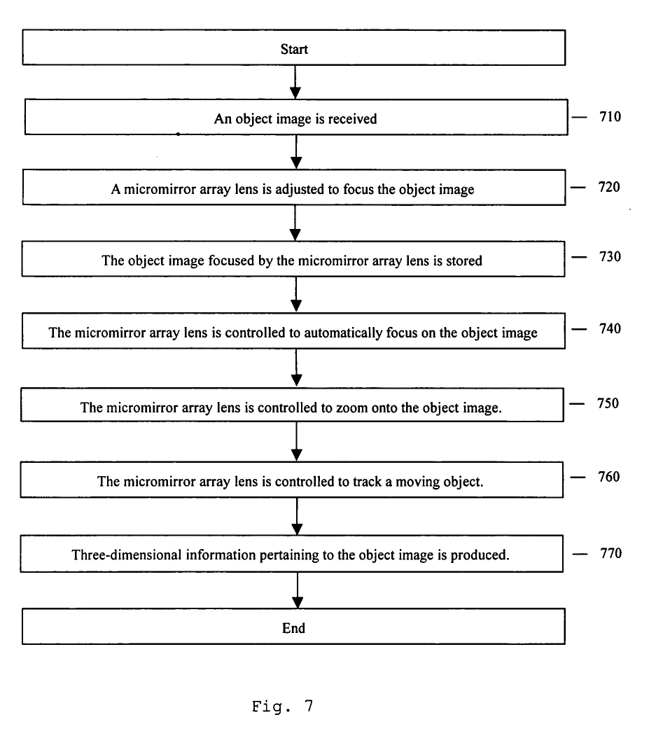

FIG. 7 is a flow diagram of a method in a video monitoring system. At step 710 of the method, an object image is received. At step 720, a micromirror array lens is adjusted to focus the object image. At step 730, the object image focused by the micromirror array lens is stored. At step 740, the micromirror array lens is controlled to automatically focus on the object image. At step 750, the micromirror array lens is controlled to zoom onto the object image. At step 760, the micromirror array lens is controlled to track a moving object. At step 770, three-dimensional information pertaining to the object image is produced. It shall be understood that not all method steps must be performed and that the method steps need not be performed in any particular order.

The advantages of the present invention include providing clear images and fast tracking and focusing of moving objects, and may also include tracking of moving objects without or with changing the attitude of the camera. If the camera attitude is not changed for tracking of moving objects, the present invention can reduce the size and cost.

While the invention has been shown and described with reference to different embodiments thereof, it will be appreciated by those skills in the art that variations in form, detail, compositions and operation may be made without departing from the spirit and scope of the invention as defined by the accompanying claims.

What is claimed is:

1. An optical system, comprising:
at least one camera system;
an objective lens system, configured to receive an object image;
at least one micromirror array lens, optically coupled to the objective lens system, configured to focus the object image received by the objective lens system onto an image sensor;
wherein the image sensor, being optically coupled to the micromirror array lens, configured to receive the focused object image from the micromirror array lens and to sense the focused object image; and
an image storage system, communicatively coupled to the at least one camera system, configured to store the object image received by the at least one camera system.

2. The optical system of claim 1, further comprising an image display device, communicatively coupled to the at least one camera system, configured to display the object image received by the at least one camera system.

3. The optical system of claim 2, wherein the image display device is a monitor.

4. The optical system of claim 1, wherein the image storage system is selected from the group consisting of an analog recording system and a digital recording system.

5. The optical system of claim 1, further comprising a zoom device, selected from the group consisting of a motor driven zoom and a manual zoom.

6. The optical system of claim 1, further comprising a zoom device, wherein the zoom device is performed using micromirror array lenses.

7. The optical system of claim 1, further comprising an auto-focus device, selected from the group consisting of a motor driven auto-focus device and a manual auto-focus device.

8. The optical system of claim 1, further comprising an auto-focus device, wherein the auto-focus device is performed using micromirror array lens.

9. The optical system of claim 1, further comprising an image processor, communicatively coupled to the image sensor, configured to process the object image sensed by the image sensor and to generate image data and position information of the object.

10. The optical system of claim 9, wherein the image processor includes at least one of the group consisting of an object identification algorithm, an object recognition algorithm, and an object tracking algorithm.

11. The optical system of claim 1, further comprising a tracking controller, communicatively coupled to the image processor, configured to generate a tracking signal to control at least one of the group consisting of an attitude of the camera system, an optical axis of the micromirror array lens, and a focal length of the micromirror array lens.

12. The optical system of claim 1, further including an algorithm selected the group consisting of an attitude control algorithm to control the attitude of the camera system, an image processing algorithm to process the object image sensed by the image sensor, and an object identification and tracking algorithm to identify and track objects.

13. The optical system of claim 1, further comprising a camera attitude driving mechanism, mechanically coupled to the camera system, configured to adjust at least one of the group consisting of camera system tilt and camera system pan.

14. The optical system of claim 13, wherein the camera attitude driving mechanism further includes at least one of the group consisting of a tilt motor and a pan motor.

15. The optical system of claim 1, further comprising a motion sensor, communicatively coupled to the camera system, configured to sense motion of a moving object.

16. The optical system of claim 1, further comprising an image transmission system, communicatively coupled to the camera system, configured to transmit images from the camera system.

17. The optical system of claim 16, wherein the image transmission system includes at least one of the group consisting of a wire, a wireless connection, and an internet connection.

18. The optical system of claim 17, wherein the wireless connection includes at least one of the group consisting of radio waves, and infrared waves.

19. A method in a video monitoring system, comprising:
receiving an object image; and
adjusting a micromirror array lens to focus the object image.

20. The method claim 19, further comprising storing the object image focused by the micromirror array lens.

21. The method claim 19, further comprising controlling the micromirror array lens to automatically focus on the object image.

22. The method claim 19, further comprising controlling the micromirror array lens to zoom onto the object image.

23. The method claim 19, further comprising controlling the micromirror array lens to track a moving object.

24. The method claim 19, further comprising producing three-dimensional information pertaining to the object image.
